(19) United States
(12) Patent Application Publication
(10) Pub. No.: US 2016/0320142 A1
(43) Pub. Date: Nov. 3, 2016

(54) THIN HEAT DISSIPATION FOIL AND METHOD FOR MANUFACTURING SAME

(71) Applicants: FuKui Precision Component (Shenzhen) Co., Ltd., Shenzhen (CN); HongQiSheng Precision Electronics (QinHuangDao) Co.,Ltd., Qinhuangdao (CN); Zhen Ding Technology Co., Ltd., Tayuan (TW)

(72) Inventors: MING-JAAN HO, New Taipei (TW); XIAN-QIN HU, Shenzhen (CN); FU-YUN SHEN, Shenzhen (CN)

(21) Appl. No.: 14/835,978

(22) Filed: Aug. 26, 2015

(30) Foreign Application Priority Data
Apr. 30, 2015 (CN) 201510217803.7

(51) Int. Cl. F28D 15/02; B32B 7/14; B32B 37/12; B32B 15/20; B32B 38/10; B32B 3/30; B32B 15/01

(52) U.S. Cl. CPC F28D 15/02; B32B 3/30; B32B 7/14; B32B 15/01; B32B 15/20; B32B 38/10; B32B 37/12

(57) ABSTRACT

A thin heat dissipation foil includes a first copper foil, a second copper foil, a plurality of bonding blocks and a working fluid. The first copper foil includes a first bonding surface, the first bonding surface defines a plurality of first receiving cavities and a plurality of first bonding recesses surrounding the first receiving cavities. The second copper foil includes a second bonding surface, the second bonding surface defines a plurality of second receiving cavities corresponding to each of the first receiving cavities. Each bonding block is located in the first bonding recess. The bonding block is configured to bond the first bonding surface and the second bonding surface to form a seamless interface, and each first receiving cavity and each second receiving cavity together form a vacuum tube. The working fluid is received in the vacuum tube.

### FIELD

The subject matter herein generally relates to heat dissipation technology, particularly to a thin dissipation foil used in an electronic device.

### BACKGROUND

Electronic devices generate heat during operation. Traditionally, the heat was removed through the use of a fan and heat sink. In some electronic devices, a heat pipe can be implemented.

### BRIEF DESCRIPTION OF THE DRAWINGS

Implementations of the present technology will now be described, by way of example only, with reference to the attached figures.

FIG. 1 is a diagrammatic view of a thin heat dissipation foil in accordance with a first embodiment.

FIG. 2 is a diagrammatic view of a thin heat dissipation foil in accordance with a second embodiment.

FIG. 3 is a diagrammatic view of a thin heat dissipation foil in accordance with a third embodiment.

FIG. 4 illustrates a flowchart of a method for manufacturing the thin heat dissipation foil of FIG. 1.

FIG. 5 illustrates a diagrammatic cross-sectional view of a first copper foil for manufacturing the thin heat dissipation foil of FIG. 1.

FIG. 6 is a diagrammatic cross-sectional view of a first dry film and a second dry film laminated on opposite surface of the first copper foil of FIG. 5.

FIG. 7 is similar to FIG. 6, but showing the first dry film is photolithography processed.

FIG. 8 is similar to FIG. 7, but showing the first copper foil is etched to form first receiving cavities.

FIG. 9 is similar to FIG. 8, but showing the first dry film is removed from the first copper foil.

FIG. 10 is similar to FIG. 9, but showing first bonding recesses are formed on the first copper foil.

FIG. 11 is similar to FIG. 10, but showing the second dry film is removed from the first copper foil.

FIG. 12 is similar to FIG. 11, but showing adhesive is filled in the first bonding recess of the first copper foil.

FIG. 13 is a top plan view of the first copper foil of FIG. 12.

FIG. 14 is similar to FIG. 12, but showing working fluid is filled in the first receiving cavities of the first copper foil.

FIG. 15 is similar to FIG. 14, but showing a second copper foil with a plurality of second receiving cavities is provided.

FIG. 16 is similar to FIG. 9, but showing the second copper foil and the first second copper foil are pressed together to form the thin heat dissipation foil of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “substantially” is defined to be essentially conforming to the particular dimension, shape, or other feature that the term modifies, such that the component need not be exact. For example, “substantially cylindrical” means that the object resembles a cylinder, but can have one or more deviations from a true cylinder. The term “comprising,” when utilized, means “including, but not necessarily limited to”; it specifically indicates open-ended inclusion or membership in the so-described combination, group, series and the like. The references “a plurality of” mean “at least two.”

The present disclosure is described in relation to a thin heat dissipation foil. The thin heat dissipation foil includes a first copper foil and a second copper foil. The first copper foil includes a plurality of first receiving cavities; the second copper foil includes a plurality of second receiving cavities. The second receiving cavities correspond with the first receiving cavities and the second copper foil is fixed on the first copper foil. An airtight vacuum tube is defined by each first receiving cavity and second receiving cavity together and a working fluid is received in the airtight vacuum tube.

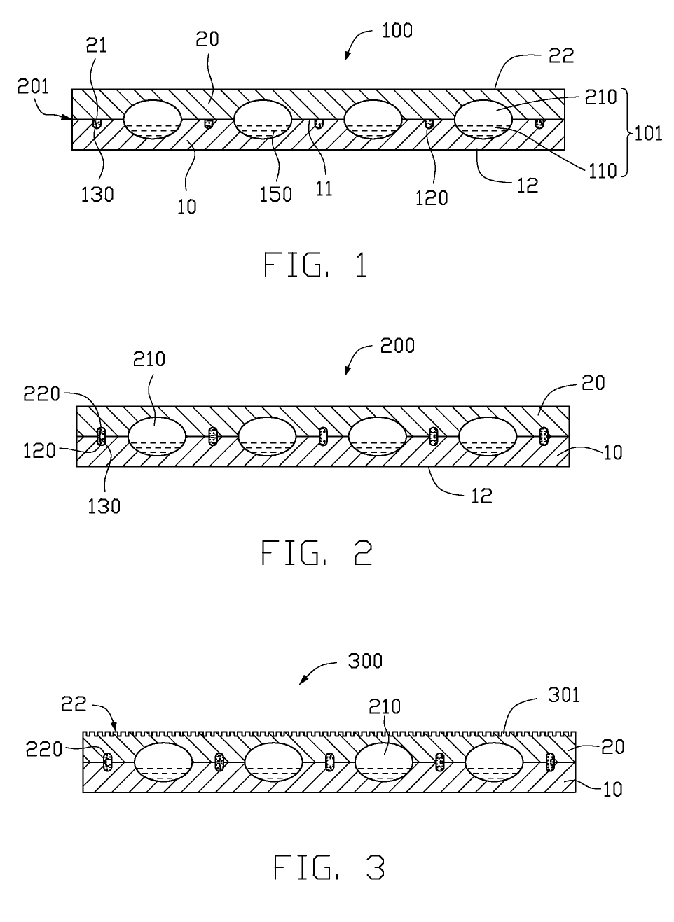

FIG. 1 illustrates a thin heat dissipation foil 100 according to one embodiment. The thin heat dissipation foil 100 includes a first copper foil 10, a second copper foil 20, a plurality of bonding blocks 130 and a working fluid 150.

A thickness of the first copper foil 10 and the second copper foil 20 are about 70 um or about 140 um. The first copper foil 10 includes a first bonding surface 11 and a heat absorbing surface 12 opposite to the first bonding surface 11. The first bonding surface 11 defines a plurality of first receiving cavities 110 randomly distributed on the first surface 101 and configured to accommodate the working fluid 150. The first bonding surface 11 also defines a plurality of first bonding recesses 120 arranged surrounding peripheral region of each first receiving cavities 110 and configured to accommodate the bonding blocks 130. A depth of the first receiving cavity 110 is greater than that of the first bonding recess 120, and a depth of each first receiving cavity 110 is less than a thickness of the first copper foil 10.

The second copper foil 20 includes a second bonding surface 21 and a heat dissipating surface 22 opposite to the second bonding surface 21. The second bonding surface 21 defines a plurality of second receiving cavities 210 corresponding to each of the first receiving cavities 110. Each of the plurality of second receiving cavities 210 has a same shape and size as a corresponding first receiving cavities 110. A cross section of the first and second receiving cavities 110 and 210 is an arc or a semicircle.

Each bonding block 130 is located in each first bonding recess 110. The bonding block 130 is configured to bond the first bonding surface 11 and the second bonding surface 21 to form a seamless interface 201. And such that each first receiving cavity 110 and each second receiving cavity 210 together form a vacuum tube 101. The first bonding block 130 is configured to prevent the working fluid from leaking.

The working fluid 150 is received in the vacuum tube 101. The working fluid 150 can be selected from the group comprising water, methanol, ethanol, acetone, ammonia, paraffin, oil, and chlorofluorocarbons etc. In the illustrated embodiment, the working fluid 150 is water.

When the thin heat dissipation foil 100 is in use, the heat absorbing surface 12 of the thin heat dissipation foil 100 is fixed with a heat source (not shown). The heat source can be a central processing unit (CPU) or other electronic components. Heat generated by the heat source is transferred to the heat absorbing surface 12 of the first copper foil 10, and the heat is absorbed by the working fluid 150 in the vacuum tube 101. The working fluid 150 is vaporized and the vapor is moved toward the second receiving cavity 210 to transfer the heat to the second copper foil 20. The second copper foil 20 dissipates the heat. The vapor on the inner wall of the second receiving cavity 210 condenses into small water droplets. The small droplets will flow into the first receiving cavity 110 again. The above mentioned process is circulated and the heat from the heat source is continuously dissipated.

A thin heat dissipation foil 200 according to a second embodiment is shown in FIG. 2. The thin heat dissipation foil 200 in FIG. 2 is similar to the thin heat dissipation foil 100 in FIG. 1. The difference between the thin heat dissipation foil 200 and the thin heat dissipation foil 100 in FIG. 1 is that the second copper foil 201 further includes a plurality of second bonding recesses 220 arranged on the second bonding surface 21. Each second bonding recess 220 corresponds with each first bonding recess 120 and surrounds the second receiving cavities 210. The first and second bonding recesses together accommodate the bonding blocks 130.

According to a third embodiment, a thin heat dissipation foil 300 is shown in FIG. 3. The thin heat dissipation foil 300 in FIG. 3 is similar to the thin heat dissipation foil 100 in FIG. 1. The difference between the thin heat dissipation foil 300 and the thin heat dissipation foil 100 in FIG. 1 is that the second copper foil 20 further includes micro-fins 301 at the heat dissipating surface 22. The micro-fins 301 are configured to increase a contact area with surrounding air and thus improving a cooling effect of the thin heat dissipation foil 300.

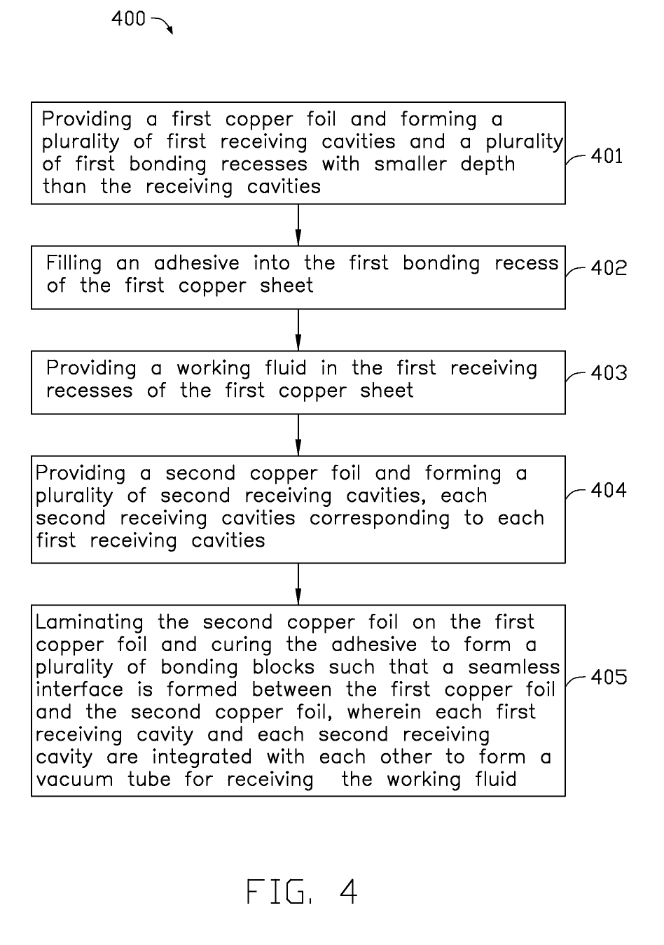

FIG. 4 illustrates a flowchart in accordance with an example embodiment. The example method 400 for manufacturing the thin heat dissipation foil 100 is provided by way of an example, as there are a variety of ways to carry out the method. Additionally, the illustrated order of blocks is by example only and the order of the blocks can change. The method 400 can begin at block 401.

At block 401, as shown in FIG. 5, a first copper foil 10 is provided, a thickness of the first copper foil 10 is about 70 um or about 140 um. The first copper foil 10 includes a first bonding surface 11. A plurality of first receiving cavities 110 are formed on the first bonding surface 11 of the first copper foil 10. The first copper foil 10 also includes a heat absorbing surface 12 opposite the first bonding surface 11. The heat absorbing surface 12 is configured to contact with a heat generating device when the thin heat dissipation foil 100 is in use. The first receiving cavities 110 are formed using a photolithography process and an etching process. The first receiving cavities 110 can be formed as described herein.

The first copper foil 10 is pretreated to remove stains, grease and other contaminants. In at least one embodiment, the first copper foil 10 is micro-etched to remove stains and grease and to ensure the surface of the first copper foil 100 has certain roughness, which is helpful for increasing a bonding force with a dry film.

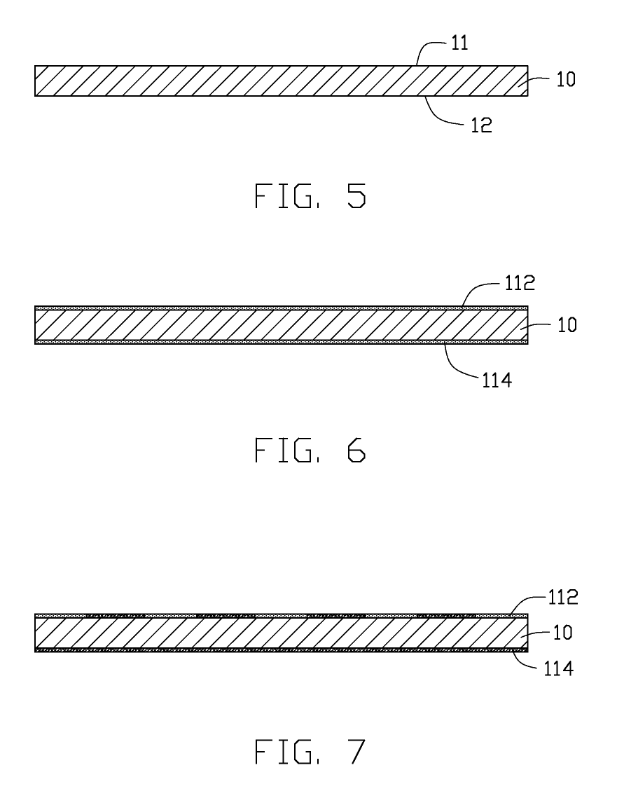

As shown in FIG. 6, a first dry film 112 is laminated on the first bonding surface 11, and a second dry film 114 is laminated on the heat absorbing surface 12. In at least one embodiment, the first dry film 112 and the second dry film 114 are a photosensitive dry film. In other embodiments, the second dry film 114 can be replaced by a low viscosity cover film, a tape, or other coating.

As shown in FIG. 7, part of the first dry foil 112 is exposed and the second dry film 114 is fully exposed.

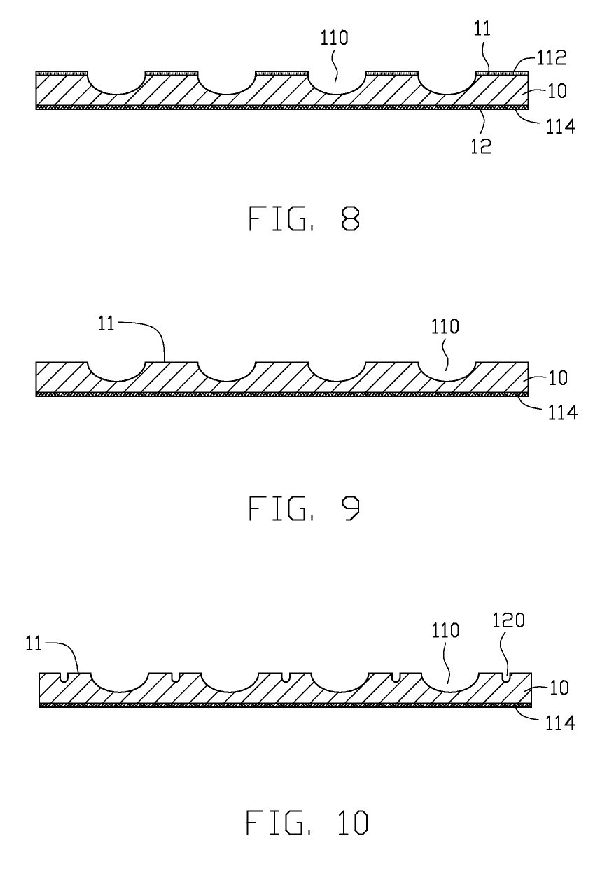

As shown in FIG. 8, a copper etching solution is provided. The first bonding surface 11 of the first copper foil 10 is etched in the copper etching solution to form the first receiving cavities 110.

As shown in FIG. 9, the first dry film 112 is removed and the first copper foil 10 with the first receiving cavities 110 is obtained.

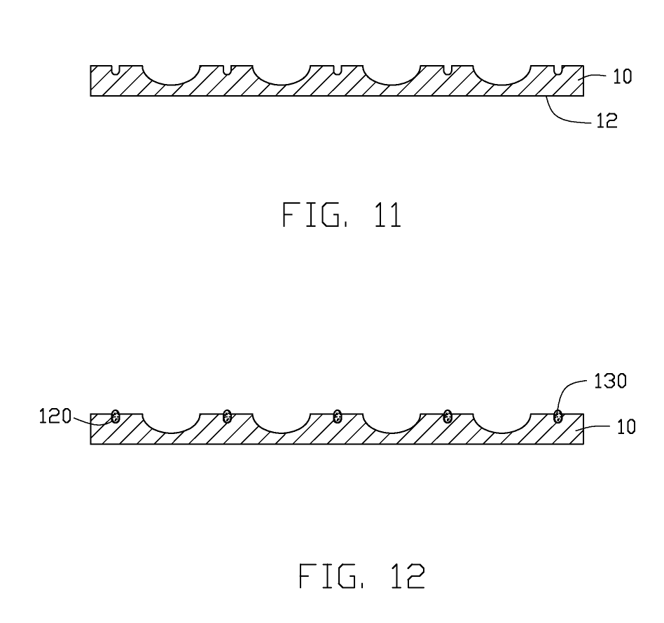

As shown in FIG. 10, the first bonding recesses 120 are formed and the first bonding recesses 120 substantially surround the first receiving cavities 110, and the bonding recess 120 has smaller depth than the receiving cavity 110. The first bonding recesses 120 are configured to receive the adhesive 130, thereby stopping the adhesive 130 from flowing into the first receiving cavities 110 and contaminating the working fluid 150.

In at least one embodiment, the first receiving cavities 110 are formed before the first bonding recesses 120, and a method for forming the first bonding recesses 120 is similar as that of forming the first receiving cavities 110. The first bonding recesses 120 also can be defined before the first receiving cavities 110 by laser ablation method.

As shown in FIG. 11, the second dry film 114 is removed, and the first copper foil 10 with the first receiving cavities 110 and the first bonding recesses 120 are obtained.

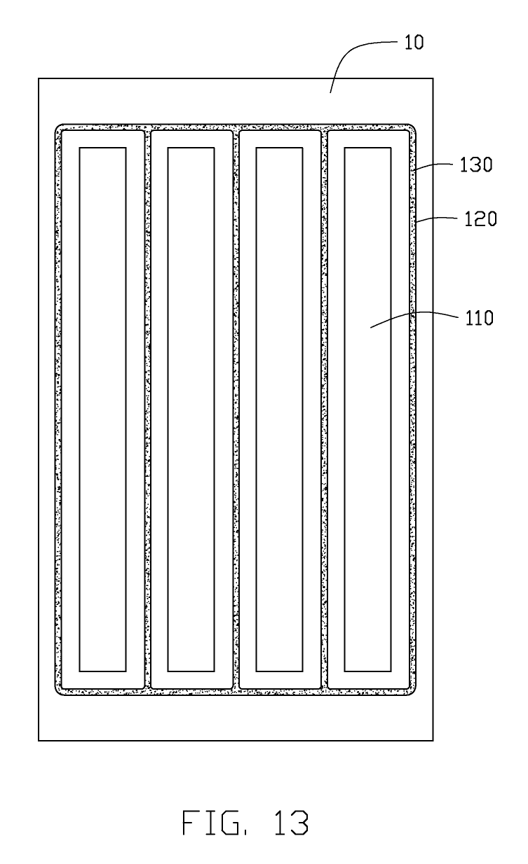

At block 402, as shown in FIG. 12 and FIG. 13, the adhesive 130 is filled in the first bonding recesses 120. A material of the adhesive 130 is molten resin material doped with metal particles, the metal particle is selected from the group comprising tin, bismuth and any combination thereof. A weight ratio of metal particle in the adhesive 130 is in the range from about 89.1% to 89.7%, a weight ratio of molten resin material in the adhesive 130 is in the range from about 10.3% to 10.7%. In an alternative embodiment, a material of the adhesive 130 is molten resin. The adhesive 130 is filled in the first bonding recesses by screen printing. A thickness of the adhesive 130 is equal to or slightly greater than the depth of the first bonding recesses 120.

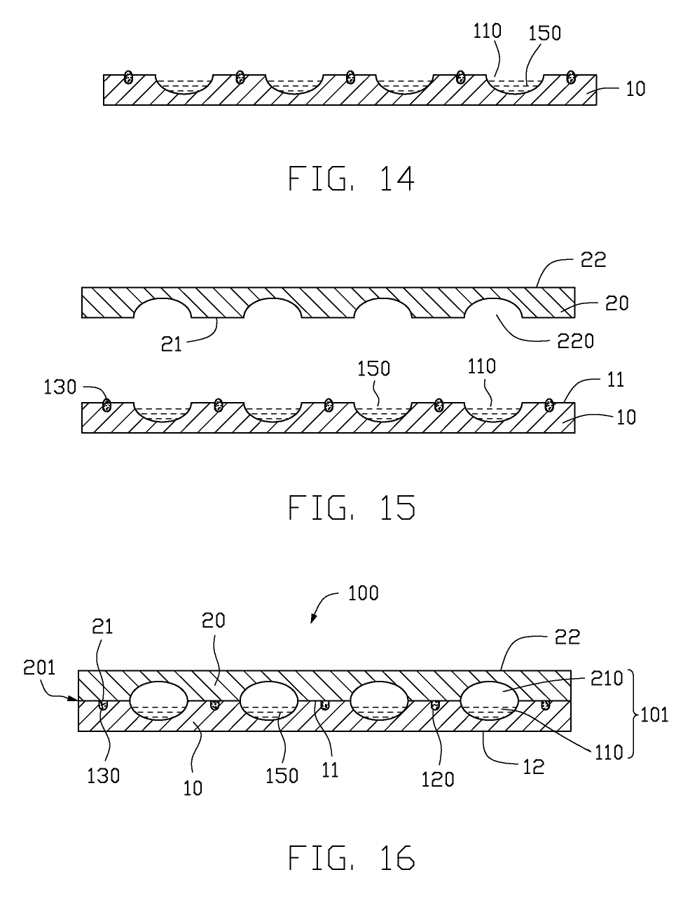

At block 403, as shown in FIG. 14, a working fluid 150 is applied in the first receiving cavities 110. The working fluid 150 is selected from the group comprising water, methanol, ethanol, acetone, ammonia, paraffin, oil, and chlorofluorocarbons. In this embodiment, the working fluid 150 is water.

At block 404, as shown in FIG. 15, a second copper foil 20 is provided, a thickness of the second copper foil is about 70 um or about 140 um. The second copper foil 20 includes a second bonding surface 21, and a plurality of second receiving cavities 210 are formed on the second bonding surface 21. The second receiving cavities 210 correspond with the first receiving cavities 110. A method for forming the second bonding recesses 210 is similar with that of the first receiving cavities 110.

At block 405, as shown in FIG. 16, the second copper foil 20 is laminated on the first copper foil 10, and the adhesive 130 is cured to form the bonding blocks 130. The second copper foil 20 is fixed with the first copper foil 10 by the bonding blocks 130, and the first bonding surface 11 and the second bonding surface 21 form a seamless interface 201, and each first receiving cavity 110 and each second receiving cavity 210 are integrated with each other to form a vacuum tube 101, thereby, the working fluid 150 is received in the vacuum tube 101, and a thin heat dissipation foil 100 is obtained.

The embodiments shown and described above are only examples. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A thin heat dissipation foil comprising:
a first copper foil comprising a first bonding surface defining a plurality of first receiving cavities and a plurality of first bonding recesses;
a second copper foil comprising a second bonding surface defining a plurality of second receiving cavities corresponding to each of the first receiving cavities;
a plurality of bonding blocks being located in the first bonding recess and being configured to bond the first bonding surface and the second bonding surface and to form a seamless interface, wherein each of the plurality of first receiving cavities and each second receiving cavities together define a vacuum tube; and
a working fluid received in the vacuum tube.

2. The thin heat dissipation foil of claim 1, wherein the second bonding surface of the second copper foil defines a plurality of second bonding recesses corresponding to each first bonding recess, each first bonding recess and each second bonding recess together receive the bonding block.

3. The thin heat dissipation foil of claim 2, wherein each of the bonding block substantially surrounds a corresponding one of the first receiving cavities.

4. The thin heat dissipation foil of claim 2, wherein the bonding block is substantially a strip locating beside the first receiving cavities.

5. The thin heat dissipation foil of claim 4, wherein the bonding block is formed by solidifying a molten resin material doped with metal particles, the metal particle is at least one selected from a group comprising tin, bismuth, and any combination thereof.

6. The thin heat dissipation foil of claim 5, wherein a diameter of the metal particle is in the range from about 25 um to 45 um.

7. The thin heat dissipation foil of claim 5, wherein a weight ratio of metal particle in the adhesive is in the range from about 89.1% to about 89.7%, a weight ratio of molten resin material in the adhesive is in the range from about 10.3% to about 10.7%.

8. The thin heat dissipation foil of claim 1, wherein the second copper foil further comprises a heat dissipating surface opposite to the second bonding surface, and a plurality of micro-fins formed at the heat dissipating surface.

9. A method for manufacturing the thin heat dissipation foil, the method comprising:
providing a first copper foil and forming a plurality of first receiving cavities and a plurality of first bonding recesses with smaller depth than the receiving cavities;
filling an adhesive into the first bonding recess of the first copper foil;
providing a working fluid in the first receiving cavities of the first copper foil;
providing a second copper foil and forming a plurality of second receiving cavities, each second receiving cavities corresponding to each first receiving cavities; and
laminating the second copper foil on the first copper foil and curing the adhesive to form a plurality of bonding blocks such that a seamless interface is formed between the first copper foil and the second copper foil, wherein each first receiving cavity and each second receiving cavity are integrated with each other to form a vacuum tube for receiving the working fluid.

10. The method of claim 9, wherein each second receiving cavity has a same shape and size with a corresponding first receiving cavities.

11. The method of claim 10, wherein the a depth of each first receiving cavities is little smaller than a thickness of the first copper foil, a depth of each second receiving cavities is little smaller than a thickness of the second copper foil.

12. The method of claim 10, wherein in the step of providing the second copper foil, the second bonding surface of the second copper foil is further processed to form a plurality of second bonding recesses, each second bonding recess has a same shape and size with a corresponding first bonding recesses.

13. The method of claim 9, wherein a material of the adhesive is molten resin material doped with metal particles, the metal particle is at least one selected from the group comprising tin, bismuth and any combination thereof.

14. The method of claim 13, wherein a weight ratio of metal particle in the adhesive is in the range from about 89.1% to about 89.7%, a weight ratio of molten resin material in the adhesive is in the range from about 10.3% to about 10.7%.

15. The method of claim 12, wherein the first bonding recesses and the second bonding recesses are formed using etching method or laser ablation method.

16. The method of claim 9, wherein the bonding block surrounds the first receiving cavities.

17. The method of claim 9, wherein the bonding block is substantially a strip shape locating beside the first receiving cavities.

18. The method of claim 9, wherein the working fluid at least is able to select from the group comprising water, methanol, ethanol, acetone, ammonia, paraffin, oil, and chlorofluorocarbons.
